(19) United States
(12) Patent Application Publication
(10) Pub. No.: US 2011/0162297 A1
(43) Pub. Date: Jul. 7, 2011

(54) WINDOW ASSEMBLY PROVIDED WITH A CLEANING DEVICE

(75) Inventor: Geurt Roelofsen, Wageningen (NL)

(73) Assignee: 4WWWWIE B.V., Ouderkerk aan de Amstel (NL)

(21) Appl. No.: 13/058,895

(22) PCT Filed: Aug. 12, 2009
(86) PCT No.: PCT/NL2009/050490

§ 371 Date: Mar. 17, 2011

(30) Foreign Application Priority Data
Aug. 15, 2008 (NL) 2001895

(51) Int. Cl. B08B 7/00; E06B 3/00

(52) U.S. Cl. 52/173.1; 52/204.5; 134/6

(57) ABSTRACT

A window assembly comprising a frame which holds a window pane, which window assembly comprises at least one cleaning device for cleaning a surface of the window pane and drive means for moving the cleaning device in a direction of movement over the window pane surface, wherein the cleaning device has a dimension which at least substantially corresponds to the dimension of the window pane in a transverse direction perpendicular to the direction of movement, wherein the cleaning device comprises at least one rotary body, which is rotatable about an axis of rotation parallel to the transverse direction, to which rotary body at least one lip and at least one cleaning element are connected, so that the lip and the cleaning element are alternately brought into contact with the window pane upon rotation of the rotary body.

The present invention relates to a window assembly provided with a cleaning device for cleaning the window pane surface.

Such a window assembly is known.

Cleaning windows of a building accessible to people, for example an office building, is usually a time-consuming activity. Especially in the case of high buildings it is difficult to reach the outer side of the windows. Generally, a cleaning cradle is used in such cases, which is passed along the windows on the outer side of the building, so that window cleaners can wash the windows from the cradle.

Furthermore, systems are known in which, for example, a wiper is automatically moved over the window pane surface, for example on the outer side of a building, for cleaning the window. Although such systems obviate the need for cleaning cradles with window cleaners, it has been found that the cleaning result obtained by using such systems is not satisfactory.

It is an object of the invention to provide an efficient window assembly provided with a cleaning device with improved cleaning capacity.

In order to accomplish that object, the invention provides a window assembly comprising a frame which holds a window pane, which window assembly comprises at least one cleaning device for cleaning a surface of the window pane and drive means for moving the cleaning device in a direction of movement over the window pane surface, said cleaning device having a dimension which at least substantially corresponds to the dimension of the window pane in a transverse direction perpendicular to the direction of movement, wherein the cleaning device comprises at least one rotary body, which is rotatable about an axis of rotation parallel to the transverse direction, to which rotary body at least one lip and at least one cleaning element are connected, so that the lip and the cleaning element are alternately brought into contact with the window pane upon rotation of the rotary body. By moving a cleaning device comprising a rotary body over the window pane surface, an efficient cleaning action is provided. As a result of said rotation, a cleaning element, for example a sponge, a chamois or other elements providing a cleaning effect, and a lip, or, in other words, a wiper, are alternately moved over the windowpane surface. Preferably, said rotary body is at least substantially cylindrical in shape.

Usually such a frame is rectangular in shape. It is advantageous in that regard if the direction of movement is parallel to the longitudinal direction of the rectangular frame, with the transverse direction corresponding to the width of the frame. The cleaning device is moved in vertical direction. It is also possible, however, for the cleaning device to extend vertically, with the direction of movement being substantially horizontal.

It should be noted that the invention is not limited solely to cleaning windows. Thus the cleaning device according to the invention can also be used for example for cleaning non-transparent surfaces, for example on the outer side of a building. The device can also be used for cleaning a mirror, for example.

Preferably, the rotary body comprises several lips and cleaning elements, said lips and said cleaning elements alternating and extending at least substantially radially around the axis of rotation. The cleaning capacity is improved in this way, since the number of cleaning elements and lips brought into contact with the surface to be cleaned with every revolution is increased. The lips and the cleaning elements extend in a star-shaped configuration, as it were, and are mounted in alternate relationship on the circumferential surface of the (preferably cylindrical) rotary body.

It has been found to be advantageous if the rotary body is arranged to rotate in a direction in such a manner that the lip and the cleaning element are moved in upward direction over the window pane surface. It has been found that this leads to an improved cleaning effect.

In a preferred embodiment of the window assembly according to the invention, at least one of said lip and said cleaning element is detachably connected to the rotary body. Since the lip and the cleaning element may exhibit wear in the long run as a result of the alternating contact, it is advantageous if said lip and said cleaning element are detachably connected to the rotary body. Preferably, the circumferential surface of the rotary body is to that end provided with slots for receiving thickenings formed on one side of at least one of said lip and said cleaning element for realising said detachable connection. The slots or recesses in the rotary body receive the ends, i.e. the ends located opposite the ends that make contact with the window pane. The lip and the cleaning element can be inserted into the slots in a direction parallel to the axis of rotation upon being provided. Preferably, the rotary body can to that end be opened on one side so as to make it possible to insert the lip and the cleaning element into the slots. The slots receive the thickenings, so that the lip and the cleaning element are properly anchored at least in radial direction.

The invention further relates to a window assembly comprising a frame which holds a window pane, which window assembly comprises at least one cleaning device for cleaning a surface of the windowpane and drive means for moving the cleaning device in a direction of movement over the window pane surface, wherein the cleaning device has a dimension at least substantially corresponding to the dimension of the window in a transverse direction perpendicular to the direction of movement, wherein the cleaning device comprises at least one lip and at least one cleaning element, as well as moving means for moving the lip and the cleaning element in directions at least substantially perpendicular to the window pane surface between a position in contact with the window pane surface and a position spaced from the window pane surface. The cleaning device according to the invention makes it possible to move the lip and the cleaning element alternately between a position in contact with the window pane surface and a position spaced from said surface. The moving means are designed to move the lip and the cleaning element independently in a direction transversely to the window pane surface. Thus it is possible, for example, to bring the cleaning element into contact with the window in an upward movement of the cleaning device and to bring the lip into contact with the window in a downward movement. It may also be possible, however, to have the moving means bring the cleaning element and the wiper alternately, or even with an overlap, into contact with the window pane surface in one movement.

Preferably, the lip and the cleaning element are each provided on a holder, which holders are movable in the cleaning device. The holders provide a strong connection with the cleaning element and the lip for the moving means, so that said moving means can move the lip and the cleaning element in an efficient manner in a direction transversely to the window pane surface. It may also be advantageous in that regard to detachably connect the lip and/or the cleaning element to the holders, thus making it possible to exchange the lip and or the cleaning element. To that end, use can be made of a slot for receiving a thickening formed on the lip or the cleaning element. It is also possible to clamp the lip or the cleaning element in the holder.

More preferably, the moving means comprise a switch disc which rotates within the cleaning device, wherein the holders of the lip and the cleaning element are connected on opposite sides of and at least substantially radially opposite locations on the switch disc for alternately bringing the lip and the cleaning element into contact with the window pane surface upon rotation of the switch disc. The switch disc is preferably mounted for rotation in a plane transversely to the window pane surface in the cleaning device and moves the holders of the lip and the cleaning element in counter phase away from and towards the windowpane surface. The holders preferably each comprise a slot and the switch disc comprises a pawl on both sides, one pawl being received in the slot of the holder for the lip and the other pawl being received in the slot of the holder of the cleaning element. Since the pawls are mounted at radially opposed locations on the switch disc, the pawls will rotate upon rotation of the disc and thus move the holders. When one of the holders is moved, the other older will automatically be moved in an opposite direction as a result of the action of the switch disc. It may also be possible to impose movement on the holders by actively rotating the switch disc.

In a preferred embodiment of the window assembly according to the invention, the moving means comprise at least one spring element, wherein at least one of said lip and said cleaning element are held under pre-tension and wherein the moving means are designed to move the lip of the cleaning element to a second position under the influence of the action of the spring element. Movement between the positions is provided in a simple manner by using a spring element, for example a spring. The lip or the cleaning element is preferably held under pre-tension in the position spaced from the window pane surface, with the lip or the cleaning element moving to the second position, into contact with the window pane surface, by releasing the lock. The spring element moreover provides a good contact between the lip or the cleaning element and the window on account of the spring action.

The moving means preferably comprise a pawl for holding the lip or the cleaning element under pre-tension in the first position, said pawl being designed to be removed upon making contact with a predetermined part of the frame for releasing the pre-tension so as to enable the lip or the cleaning element, as the case may be, to move to the second position. The pawl thus provides the lock for holding the lip or the cleaning element under pre-tension in the first position. The holder of the lip or the cleaning element may to that end be provided with a recess for receiving the pawl. When the pawl is removed from the recess, the holder will move to the second position. Activation of the pawl takes place by the frame, for example through contact with the crossbeams of the frame at the ends of the path of movement. When the cleaning device is then moved in the direction of movement over the window pane and eventually comes into contact with the frame, the pawl will be activated, for example by being depressed by the frame, and be removed, allowing the lip or the cleaning element to move to the second position.

In another preferred embodiment of the window assembly according to the invention, the frame comprises a guide slot extending at least substantially in the direction of movement, wherein at least one of the lip and the cleaning element comprises a pin, which is accommodated in the guide slot, and wherein the guide slot is designed to move the lip or the cleaning element between the positions. The slot extends in such a manner that the lip or the cleaning element follows the slot via the pin. The spacing between the lip or the cleaning element and the window can be adjusted by varying the spacing between the slot and the window pane surface in the direction of movement. Preferably, a frame beam extending parallel to the direction of movement is provided with the slot. It is possible in this regard that one frame beam, which extends parallel to the direction of movement, is provided with a slot for moving the lip between the two positions, whilst the other parallel beam is provided with a slot for moving the cleaning element between the positions.

In another preferred embodiment of a window assembly according to the invention, the drive means comprise at least one externally threaded spindle, wherein the cleaning device engages the spindle and wherein the drive means are designed to rotate the spindle for moving the cleaning device in the direction of movement. Preferably, two spindles are provided on either side of the frame, with the cleaning device extending between the two spindles, which cleaning device can be moved by the rotation of the two spindles.

In another preferred embodiment of a window assembly according to the invention, the frame comprises at least one passage for providing access to the cleaning device from inside the building, which cleaning device is designed to clean the windows surface on the outer side of the building. This makes it possible to access the cleaning device present on the outer side of a building without having to use a cradle, for example for exchanging a lip or a cleaning element. Preferably, the passage extends into a beam of the frame on one side in the direction of movement. When the cleaning device takes up an extreme position in the direction of movement, access to the cleaning device is possible. Preferably, said passage can be closed.

In another preferred embodiment of a window assembly according to the invention, the window assembly comprises means for applying moisture and/or cleaning agents to the window pane surface. Said application means preferably extend at the upper side of the frame, so that the moisture and/or the cleaning agent can be distributed over the window pane surface. The application means may be in the form of a cistern. Preferably, the window assembly furthermore comprises collecting means for collecting the moisture and/or the cleaning agents, in which case the window assembly comprises guide means for guiding the collected moisture and/or the cleaning agents to the means for applying the moisture and/or the cleaning agents. More preferably, the collecting means extend at the bottom side of the frame. The collecting means may be integral with a beam at the bottom side of the frame, for example. The guide means, preferably in the form of a hose provided with a pump, provide a closed system, so that the amount of moisture supplied to the frame is limited. More preferably, the guide means comprise a filter for filtering the collected moisture before the moisture is applied to the window pane surface again.

In another preferred embodiment of a window assembly according to the invention, the drive means comprise a drive unit, which drive unit is detachably connected to the frame. Preferably, a drive shaft is provided for driving the drive means, for example the endless belt or the spindle, wherein the shaft is designed to be connected to a drive unit, for example an electric motor. The use of a detachable electric motor obviates the need to provide every frame with such a drive unit, which reduces the costs of such a frame significantly. By connecting the detachable drive unit to the frame, the cleaning device can be moved over the window pane surface.

In another preferred embodiment of a window assembly according to the invention, at least part of the frame is movable in the direction of movement under the influence of the cleaning device. Preferably, at least one beam of the frame, which extends perpendicularly to the direction of movement, is designed to be moved, for example by being compressed under the influence of the approaching cleaning device. More preferably, said part is designed to move back again once the cleaning device is positioned some distance away from said part of the frame again. This achieves that also the parts near the frame in the direction of movement can be reached by the lip and/or the cleaning element, so that the entire visible part of the window pane is cleaned.

The invention further relates to a method for cleaning windows surface, comprising the step of moving a cleaning device over the window pane surface in a direction of movement and rotating a rotary body provided with at least one lip and at least one cleaning elements, which lip and which cleaning element are alternately brought into contact with the window pane surface. Said alternately bringing the lip and the cleaning element into contact with the window pane surface preferably comprises the rotating of a rotary body provided with the lip and the cleaning element. According to another possibility, said alternately bringing into contact comprises moving the lip and the cleaning element in a direction transversely to the window pane surface.

The invention will now be explained in more detail with reference to figures of a drawing of a preferred embodiment of the invention, in which:

FIG. 1 schematically shows a window assembly according to the invention;

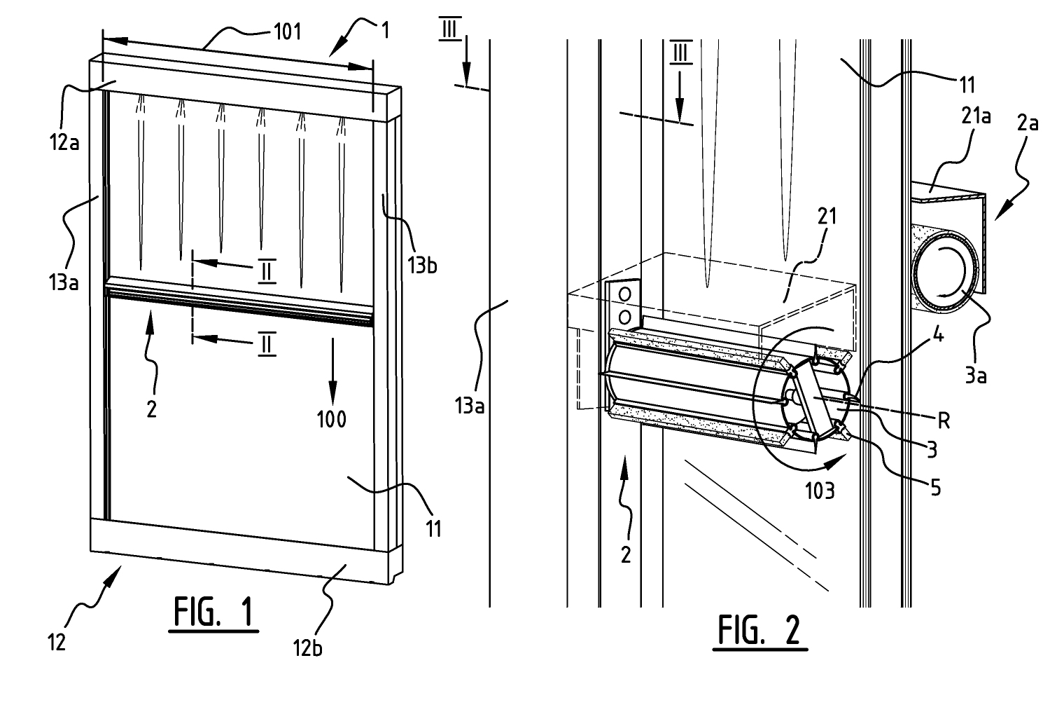

FIG. 2 schematically shows a detail of FIG. 1, seen in the direction II;

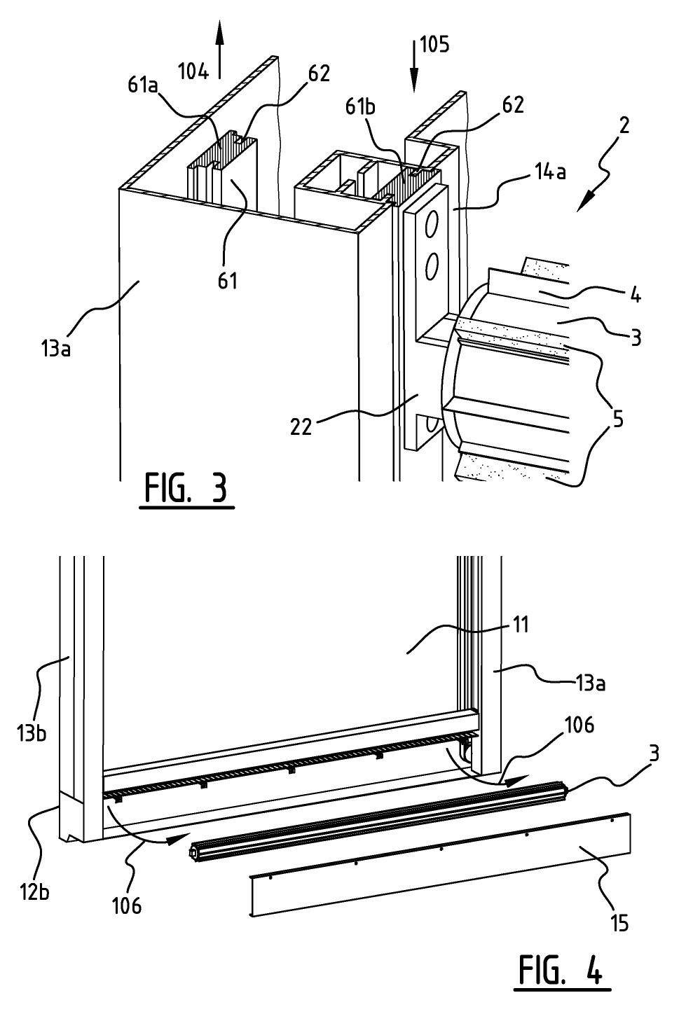

FIG. 3 schematically shows a cross-section of the frame, seen in the direction III shown in FIG. 2;

FIG. 4 schematically shows a passage for accessing the cleaning device;

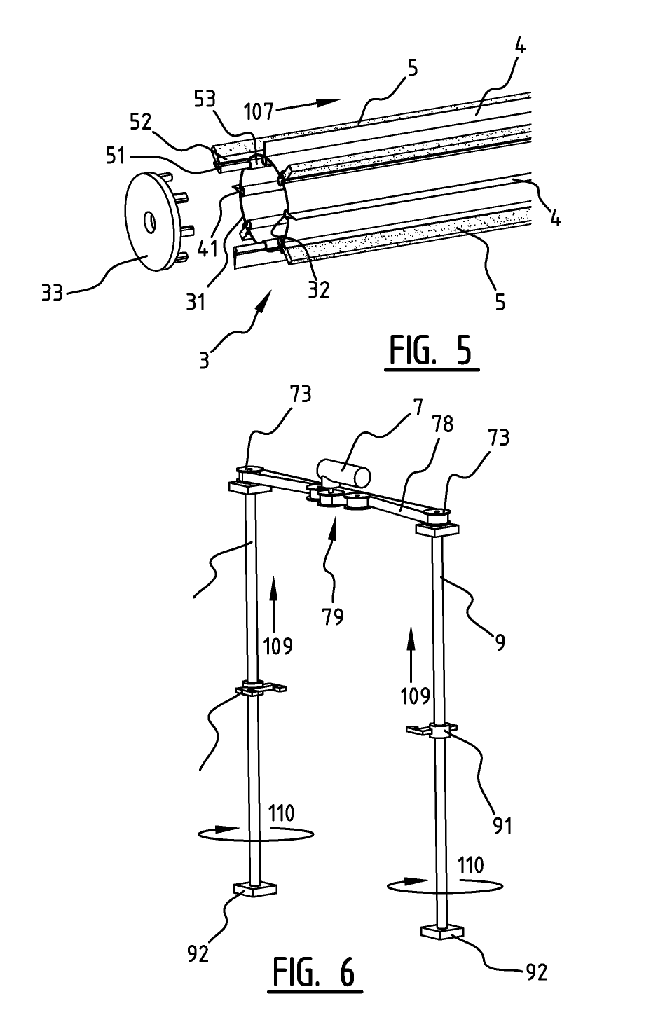

FIG. 5 schematically shows the rotary body;

FIG. 6 schematically shows the drive means;

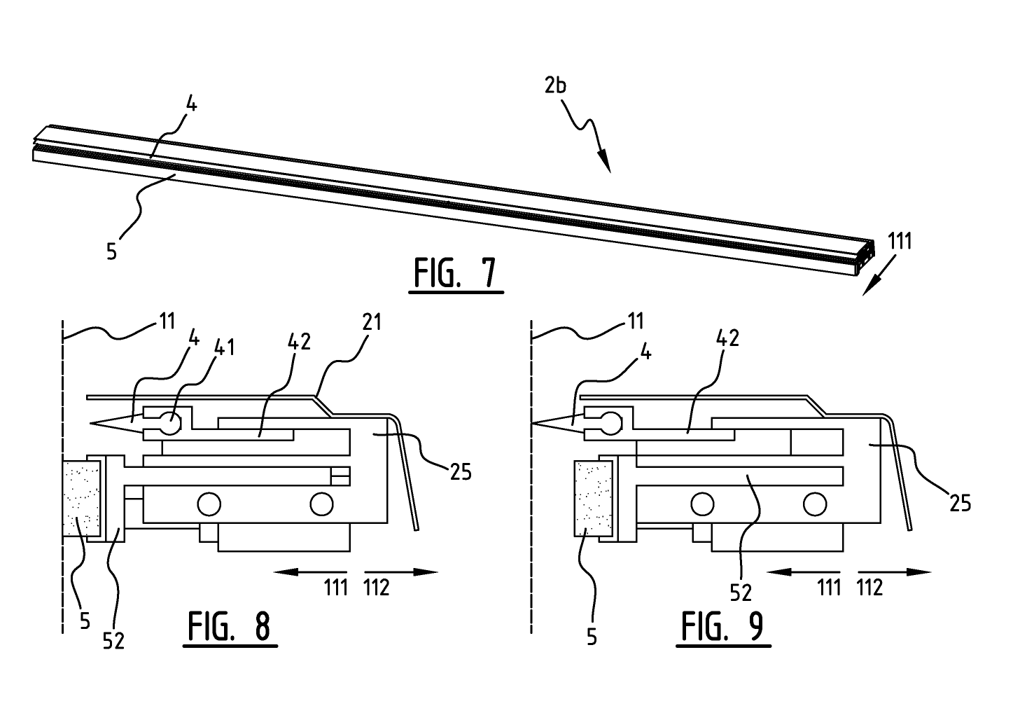

FIG. 7 schematically shows another embodiment of the cleaning device;

FIGS. 8 and 9 schematically show the cleaning device of FIG. 7 in the various positions thereof;

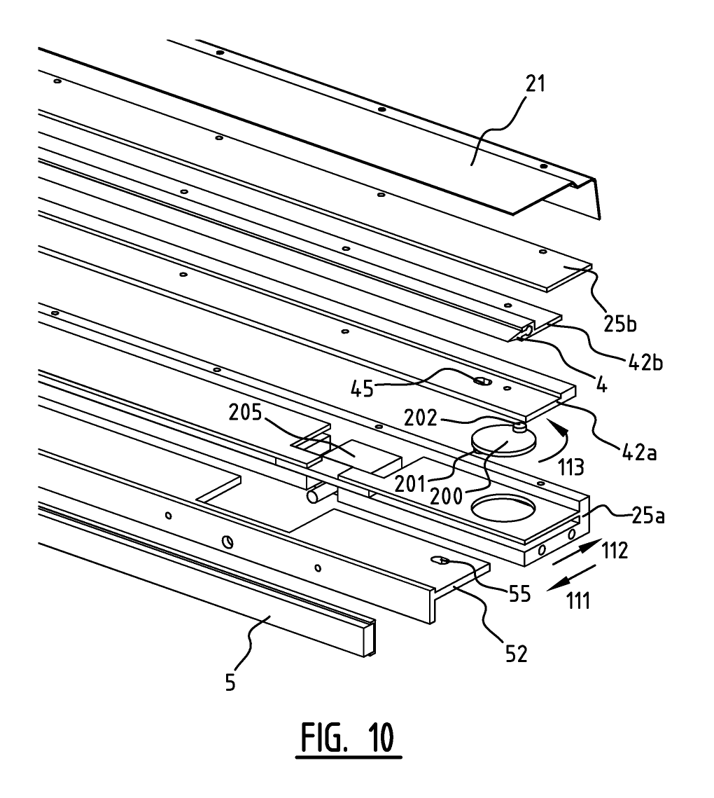

FIG. 10 schematically shows the cleaning device in exploded view; and

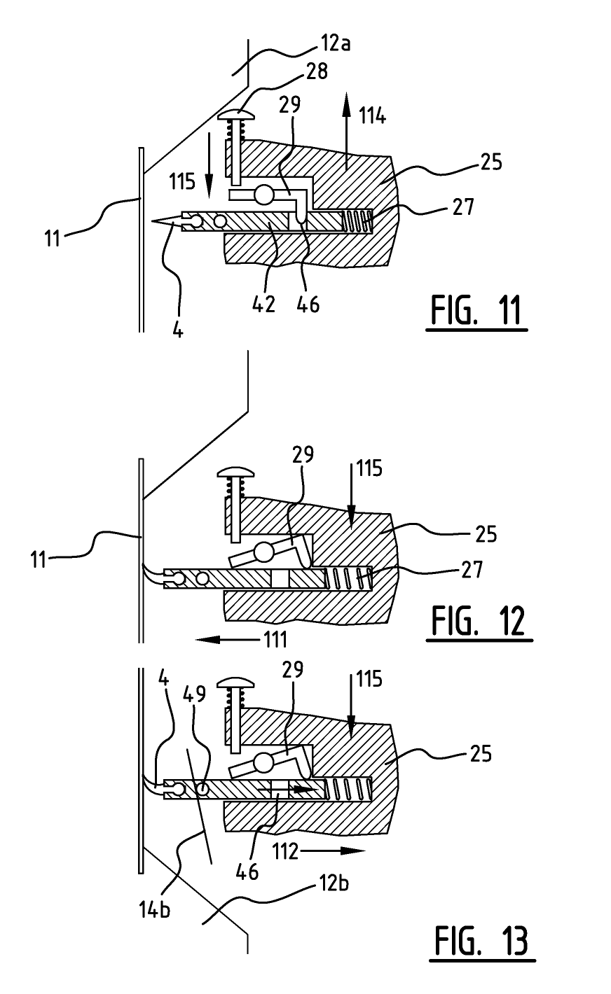

FIGS. 11-13 schematically show the cleaning device provided with another embodiment of the moving means during various steps.

In FIG. 1 a window assembly 1 comprising a frame 12 is shown. The frame 12 is made up of cross beams 12a and 12b at the upper side and the bottom side of the frame 12, and comprises sections 13a and 13b on the sides. The frame 12 is designed to hold a window pane 11. For cleaning the surface of the window pane 11, a cleaning device in the form of a cleaner 2 is provided on the outer side of the building. The cleaning device 2 has a width 101 which corresponds to the distance between the sections 13a and 13b on either side of the window pane 11. The cleaner 2 is designed to be moved over the window pane 11 in a direction of movement parallel to the direction 100. Furthermore shown are the means for applying liquid and/or cleaning agents, which means are configured as nozzles which are integrated in the upper section 12a of the frame 12.

In FIG. 2 the cleaner 2 is shown in cross-sectional view in the direction II of FIG. 1. The cleaner 2 comprises a rotary body 3, to which lips in the form of wipers 4 and cleaning elements in the form of sponges 5 are connected. The wipers 4 and the sponges 5 extend radially around the axis of rotation R of the rotary body 3 and are arranged alternately. The ends of the wipers 4 and the sponges 5 that make contact with the window pane 11 extend at substantially the same radial distance from the axis of rotation R, so that the wipers 4 and the sponges 5 each make good contact with the windowpane 11. The cleaner 2 is furthermore designed to rotate the rotary body 3 in a direction indicated at 103, so that the lips 3 and the sponges 5 are moved in an upward movement along the pane 11. The cleaner is to that end provided with a suitable drive unit, for example in the form of an electric motor. The cleaner 2 further comprises a suitable housing 21 for protecting the rotary body 3, for example against weather influences.

A cleaner 2a comprising a housing 21a and a rotary body 3a is provided on the inner side of the window pane 11 as well. The rotary body 3a has a cleaning surface, for example made of sponge. The cleaner 2a, too, is designed to be moved parallel to the direction 100 for cleaning the window pane 11 on the inner side of the building.

In FIG. 3 the section 13a of the frame 12 is shown in cross-sectional view, seen from the direction III in FIG. 2. As shown, the frame 12 is made up of hollow sections, in which the drive means in the form of an endless belt 61 extend. The section 13a is provided with a recess on one side 14a, in which a part 61b of the endless belt 61 extends. The other part 61a extends in the section 13a of the frame 12. To form a good seal, the endless belt 61 is provided with recesses 62, in which the edges of the recesses in the surface 14a can be received.

The endless belt 61 is designed to move the cleaner 2 in the direction of movement 100 over the surface of the window pane 11. The cleaner 2 is to that end connected to the endless belt 61 by means of a connection 22. When the endless belt 61 is driven, the part 61, and thus also the cleaner 2, will move downwards, for example, as indicated at 105, whilst the other part 61a moves upwards, as indicated at 104.

FIG. 4 shows the bottom side of the frame 12, seen from inside the building. The lower section 12b is provided with a passage for providing access to the cleaning device and in particular the rotary body 3 from inside the building. The section 12a is to that end provided with a removable part 15. When the part 15 is removed, the rotary body 3 can be removed from the cleaner 2, as indicated by arrows 106.

The rotary body 3 is shown in more detail in FIG. 5. The rotary body 3 is substantially cylindrical in shape, its circumferential surface 31 being provided with slots or recesses 32. The slots 32 are designed to receive the lips 4 and the sponges 5. The lips 4 are to that end provided with a thickening 41, which can be received in the slots 32. The cleaning elements in the form of sponges 5 are also provided with a holder 52 with a thickening 51, which can be received in the slots 32. The slots 32 and the thickenings 41 and 51 are designed to allow practically no movement in radial direction. To connect a lip 4 or a sponge 5, one end 33 of the body 3 can be removed, so that the sponges 5 and the lips 4 can be moved in a direction 107 into the slots 32. After the lips 4 or the sponges 5 have been provided or replaced, the end 33 can be connected again.

In FIG. 6 the drive means comprise spindles 9 provided with external screw thread. The spindles 9 are supported for rotation on feet 92 and are rotated by rollers 73 by means of a motor 7, a transmission 79 and a belt 78. The cleaner 3 is mounted on connections 91, which engage the screw thread of the spindles 9. Rotation of the spindles 9 in a direction 110 will cause the connections 91 to move in a direction 109, for example.

In FIG. 7 a second embodiment of a cleaning device in the form of a cleaner 2b is shown. The cleaner 2b comprises a lip or wiper 4 and a cleaning element in the form of a sponge 5. The cleaner 2b is designed to move the wiper 4 and the sponge 5 in a direction transversely to the window pane surface, indicated as the direction 111, so as to move the wiper 4 and the sponge 5 between a position in contact with the surface of the window pane 11 and a position spaced from the windowpane 11. In FIG. 8 the cleaner 2b is shown in cross-sectional view, with the sponge 5 in the position in which it makes contact with the window pane 11. The wiper 4 is now spaced from the window pane 11. In FIG. 9, however, the wiper 4 is in the position in which it makes contact with the window pane 11, whilst the sponge 2 is retracted from the surface of the window pane 11.

To enable movement between the two positions, the cleaner 2b is designed to move the wiper 4 and the sponge 5 in directions 111 and 112 transversely to the surface of the window pane 11. The wiper 4 is to that end connected to a holder 42, for example via a thickening 41 which is received in a slot, being movable within the body 25 of the cleaner 2b. The sponge 5, too, is connected to a holder 52 and movable within the body 25. To enable movement from the position shown in FIG. 8 to the position shown in FIG. 9, the holder 42 is moved in a direction 111, whilst the holder 52 is moved in a direction 112. The cleaner 2b is provided with moving means (shown in more detail in FIG. 10) to enable movement between the positions.

In FIG. 10 the cleaner 2 is shown in exploded view. Seen from the top down in FIG. 10, the cleaner 2b comprises a housing 21, a first body part 25, a first holder part 42b, a second holder part 42a, a second body part 25a and a holder 52 for the sponge 5. The holder 42 of the wiper 4 is formed by connecting the parts 42a and 42b. The body parts 25a and 25b are connected one on top of the other, so that a slot is formed, in which the holder 42 extends. The holder 52 extends in a slot in the second body part 25a.

A switch disc 200 extends in the body 25 of the cleaner 2b. The disc 200 extends in a plane transversely to the surface of the window pane 11. Pawls 201 and 202 are present on either side of the disc 200, which pawls are provided at radially opposite locations near the circumferential edge of the disk 200. The holders 42 and 52 are each provided with a slot 45 and 55 for receiving the pawls 202 and 201, respectively. Moving means in the form of an actuator 205 are furthermore provided for moving the holder 52 in a direction 111 or 112.

When the cleaner 2b is in the position shown in FIG. 8, i.e. with the sponge 5 in contact with the window pane 11, and the actuator 205 moves the holder 52 in the direction 112, the pawl 201 will be moved through the slot 55, so that the switch disc 200 will rotate in a direction 113. The pawl 202 will thus also rotate in a direction 113, as a result of which the pawl 202, which is accommodated in the slot 45, will move the holder 42 in a direction 111, so that the situation shown in FIG. 9 is reached. The wiper and the sponge are thus alternately brought into contact with the window pane. The switch disc rotates 180° upon moving between the positions shown in FIGS. 8 and 9, so that a pawl is rotated from a position towards the window pane to a position away from the window pane and vice versa, carrying along the holder connected thereto.

In FIGS. 11-13 another embodiment of the moving means is shown. The moving means comprise a spring element in the form of a spring 27 for holding the lip 4, and in particular the holder 42, under pre-tension in a first position. In this embodiment the holder 42 is held under pre-tension in the position spaced from the windowpane 11. A pivoting pawl 29 is to that end provided, which pawl is positioned in an opening 46 in the holder 42, thereby limiting the movement of the holder 42. A switch 28 is moreover provided, which is fitted to the body 25 of the cleaner 2b by means of a spring. When the cleaner 25 is moved in a direction 114, the switch 28 will make contact with the upper section 12a. As a result, the switch 28 will be depressed in a direction 115, causing the pawl 29 to pivot, so that the pawl 29 is removed from the holder 42. The holder 42 will subsequently move in a direction 111 as shown in FIG. 12 under the influence of the action of the spring 27 towards the second position, in this case in the position in contact with the window pane 11. The cleaner subsequently moves downwards in a direction 115 for wiping the window pane 11. The spring 27 ensures that the lip 4 properly abuts the surface of the window pane 11.

To move the holder 42 back to the first position, a side wall, for example the wall 14a in FIG. 3, is provided with a guide in the form of an upright edge or slot 14b, see FIG. 13. A pin 49 attached to the holder 42 engages in the slot 14b. The slot 14b extends near the bottom side 12b of the window pane 11 in a direction away from the window pane surface, so that the pin 49, and thus the holder 42, is forced in a direction 112 against the action of the spring 27. Eventually, the pawl 29 will slip back into the opening 46, so that the holder 42 is held under pre-tension again, as shown in FIG. 11.

It is noted that the invention is not limited to the illustrated embodiment is, but they also extends to other preferred variants that fall within the scope of the appended claims.

1. A window assembly comprising a frame which holds a window pane, which window assembly comprises at least one cleaning device for cleaning a surface of the window pane and drive means for moving the cleaning device in a direction of movement over the window pane surface, wherein the cleaning device has a dimension which at least substantially corresponds to the dimension of the window pane in a transverse direction perpendicular to the direction of movement, wherein the cleaning device comprises at least one rotary body, which is rotatable about an axis of rotation parallel to the transverse direction, to which rotary body at least one lip and at least one cleaning element are connected, so that the lip and the cleaning element are alternately brought into contact with the window pane upon rotation of the rotary body.

2. A window assembly according to claim 1, wherein the rotary body comprises several lips and cleaning elements, said lips and said cleaning elements alternating and extending at least substantially radially around the axis of rotation.

3. A window assembly according to claim 1, wherein the rotary body is arranged to rotate in a direction in such a manner that the lip and the cleaning element are moved in upward direction over the window pane surface.

4. A window assembly according to claim 1, wherein at least one of said lip and said cleaning element is detachably connected to the rotary body.

5. A window assembly according to claim 4, wherein the circumferential surface of the rotary body is provided with slots for receiving thickenings formed on a one of at least one of said lip and said cleaning element for realising said detachable connection.

6. A window assembly comprising a frame which holds a window pane, which window assembly comprises at least one cleaning device for cleaning a surface of the window pane and drive means for moving the cleaning device in a direction of movement over the window pane surface, wherein the cleaning device has a dimension at least substantially corresponding to the dimension of the window in a transverse direction perpendicular to the direction of movement, wherein the cleaning device comprises at least one lip and at least one cleaning element, as well as moving means for moving the lip and the cleaning element in directions at least substantially perpendicular to the window pane surface between a position in contact with the window pane surface and a position spaced from the window pane surface.

7. A window assembly according to claim 6, wherein the lip and the cleaning element are each provided on a holder, which holders are movable in the cleaning device.

8. A window assembly according to claim 7, wherein the moving means comprise a switch disc which rotates within the cleaning device, wherein the holders of the lip and the cleaning element are connected on opposite sides of and at least substantially radially opposite locations on the switch disc for alternately bringing the lip and the cleaning element into contact with the window pane upon rotation of the switch disc.

9. A window assembly according to claim 6, wherein the moving means comprise at least one spring element, wherein at least one of said lip and said cleaning element are held under pre-tension and wherein the moving means are designed to move the lip of the cleaning element to a second position under the influence of the action of the spring element.

10. A window assembly according to claim 9, wherein the moving means comprise a pawl for holding the lip or the cleaning element pre-tensioned in the first position, said pawl being designed to be removed upon making contact with a predetermined part of the frame for releasing the pre-tension so as to enable the lip or the cleaning element, as the case may be, to move to the second position.

11. A window assembly according to claim 6, wherein the frame comprises a guide slot extending at least substantially in the direction of movement, wherein at least one of the lip and the cleaning element comprises a pin, which is accommodated in the guide slot, and wherein the guide slot is designed to move the lip or the cleaning element between the positions.

12. A method for cleaning windows surface, comprising the step of moving a cleaning device over the window pane surface in a direction of movement and rotating a rotary body provided with at least one lip and at least one cleaning elements, which lip and which cleaning element are alternately brought into contact with the window pane surface.

13. A window assembly according to claim 2, wherein the rotary body is arranged to rotate in a direction in such a manner that the lip and the cleaning element are moved in upward direction over the window pane surface.

14. A window assembly according to claim 2, wherein at least one of said lip and said cleaning element is detachably connected to the rotary body.

15. A window assembly according to claim 3, wherein at least one of said lip and said cleaning element is detachably connected to the rotary body.

16. A window assembly according to claim 7, wherein the moving means comprise at least one spring element, wherein at least one of said lip and said cleaning element are held under pretension and wherein the moving means are designed to move the lip of the cleaning element to a second position under the influence of the action of the spring element.

17. A window assembly according to claim 8, wherein the moving means comprise at least one spring element, wherein at least one of said lip and said cleaning element are held under pretension and wherein the moving means are designed to move the lip of the cleaning element to a second position under the influence of the action of the spring element.

18. A window assembly according to claim 7, wherein the frame comprises a guide slot extending at least substantially in the direction of movement, wherein at least one of the lip and the cleaning element comprises a pin, which is accommodated in the guide slot, and wherein the guide slot is designed to move the lip or the cleaning element between the positions.

19. A window assembly according to claim 8, wherein the frame comprises a guide slot extending at least substantially in the direction of movement, wherein at least one of the lip and the cleaning element comprises a pin, which is accommodated in the guide slot, and wherein the guide slot is designed to move the lip or the cleaning element between the positions.

20. A window assembly according to claim 9, wherein the frame comprises a guide slot extending at least substantially in the direction of movement, wherein at least one of the lip and the cleaning element comprises a pin, which is accommodated in the guide slot, and wherein the guide slot is designed to move the lip or the cleaning element between the positions.

21. A window assembly according to claim 10, wherein the frame comprises a guide slot extending at least substantially in the direction of movement, wherein at least one of the lip and the cleaning element comprises a pin, which is accommodated in the guide slot, and wherein the guide slot is designed to move the lip or the cleaning element between the positions.
